(19) United States
(12) Patent Application Publication
(10) Pub. No.: US 2012/0321845 A1
(43) Pub. Date: Dec. 20, 2012

(54) METHOD FOR PRODUCING HONED SEGMENT BORES IN WORK PIECES AND WORK PIECE HAVING A HONED SEGMENT BORE

(75) Inventors: Karl Forsch, Homburg (DE); Marco Schneiders, Huettigweiler (DE); Guido Stopp, Gersheim (DE); Ralf Burkholder, Zweibruecken (DE); Andreas Strasser, Martinshoehe (DE)

(73) Assignee: ROBERT BOSCH GMBH, Stuttgart (DE)

(21) Appl. No.: 13/516,761

(22) PCT Filed: Oct. 25, 2010
(86) PCT No.: PCT/EP2010/066061

§ 371 Date: Sep. 4, 2012

(30) Foreign Application Priority Data
Dec. 18, 2009 (DE) 10 2009 054 946.3

(51) Int. Cl. B24B 33/02; B32B 3/24

(52) U.S. Cl. 428/137; 451/61

(57) ABSTRACT

The invention relates to a method for producing a honed segment bore (5-8) in work pieces (1-4), which each have a segment bore (5-8). The work pieces (1-4) are arranged relative to each other such that the segment bores (5-8) of the work pieces (1-4) are aligned to a common longitudinal axis (9) and a closed circle (12) is formed in a projection along the common longitudinal axis (9). The segment bores (5-8) of the work pieces (1-4) arranged relative to each other are then honed together. An elaborate grinding process can thus be replaced by a honing process, in which a plurality of work pieces (1-4) can be processed simultaneously, thus reducing the cycle time.

### BACKGROUND OF THE INVENTION

The invention relates to the area of work pieces in which segment bores are provided, which, for example, have the function of a bearing.

When designing segmented bores, in particular half shells which serve as bearings, the qualitative features, form and bearing tolerances, diameter tolerances and surface qualities can be produced by means of grinding. The grinding of segment bores is however very cost and time intensive. High costs result thereby.

### SUMMARY OF THE INVENTION

The method according to the invention and the work piece according to the invention have in contrast the advantage that a cost effective production of a segment bore having advantageous properties is facilitated. The advantage is particularly that segmented bores can be produced in all angle variants.

The qualitative features, form and bearing tolerances, diameter tolerances and surface qualities of a segmented bore can, for example, be determined by the form and bearing tolerances being less than 2 μm, the diameter tolerances being less than 20 μm and surface qualities being achieved which have a roughness (Rz value) of less than 2 μm. In contrast to a grinding process, such quality features can be cost effectively achieved by honing. The tribological properties of a surface produced by means of honing have in this case a positive effect on the sliding and lubrication properties.

It is advantageous that the work pieces are arranged relative to each other such that in a projection along the common longitudinal axis, the segment bores of the work pieces form a closed circle in a multiple superposition. A reliable guidance of the honing tool, in particular a honing mandrel, is hereby ensured. The multiple superposition can in this case be twofold or also preferably more than twofold. In so doing, the guidance of the honing tool can be further improved as needed.

It is also advantageous that the work pieces are arranged at least partially distributed along the longitudinal axis. In so doing, it is further advantageous for at least two adjacent work pieces of the work pieces arranged distributed along the longitudinal axis to be arranged around the common longitudinal axis such that the segment bores of the adjacent work pieces have a slight overlap in the projection along said common longitudinal axis. Said adjacent work pieces can especially be arranged around said common longitudinal axis such that the segment bores of said adjacent work pieces have a minimal overlap in the projection along said common longitudinal axis. In so doing, lateral forces acting on the honing tool during honing and deflections of the honing tool caused thereby are reduced. A uniform guidance of the honing mandrel in the region of the segment bores of the work pieces along said common longitudinal axis and consequently a uniform chip removal is thereby facilitated. In this way, the desired qualitative features can be advantageously achieved.

It is also advantageous that the work pieces are rigidly arranged and that a honing mandrel is gimbal-mounted; said honing mandrel being guided to hone the segment bores of the work pieces, which are arranged relative to each other, with a feed along the common longitudinal axis through the segment bores. It is however also an option for the work pieces to be gimbal-mounted in each case and for a honing mandrel to be rigidly mounted; said honing mandrel being guided to hone the segment bores of the work pieces, which are arranged relative to each other, relative to said work pieces along the common longitudinal axis through the segment bores. This facilitates advantageous configurations with regard to the tool and work piece mounting, wherein a plurality of work pieces can be simultaneously processed. Cycle times are thereby significantly reduced; however, still other combinations of tool and work piece mountings are conceivable.

In an advantageous manner, the work piece which comprises the honed segment bore serves as the bearing element, wherein the honed segment bore serves as a bearing surface. In this case, it is further advantageous for the honed segment bore to be designed as a partially cylindrical, honed segment bore. The work piece can be specifically designed as a half shell. In so doing, the bearing element can, for example, serve to receive a roller on the honed segment surface. The tribological properties of the bearing surface of the work piece produced by means of honing have in this case a positive effect on the sliding and lubrication properties.

It is therefore possible to hone bore segments in an advantageous manner. Using the method, a plurality of components is simultaneously processed, and therefore short cycle times result. The tribological properties with regard to the machining marks typical for the method have a positive effect on the sliding and/or lubrication properties.

### BRIEF DESCRIPTION OF THE DRAWINGS

Preferred exemplary embodiments of the invention are explained in detail in the subsequent description with reference to the attached drawings, in which corresponding elements are provided with identical reference numerals. In the drawings:

FIG. 1 shows an arrangement of work pieces to illustrate the inventive method corresponding to one exemplary embodiment;

FIG. 2 shows the arrangement of the work pieces depicted in FIG. 1 from the viewing direction which is denoted with the symbol II and

FIG. 3 shows a work piece which is produced using a method in accordance with the exemplary embodiment of the invention.

### DETAILED DESCRIPTION

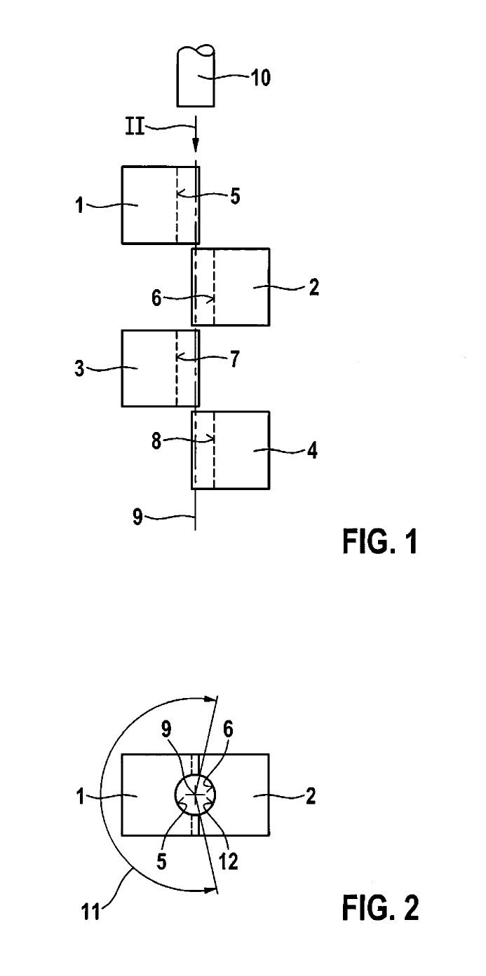

FIG. 1 shows an arrangement of work pieces 1, 2, 3, 4 having segment bores 5, 6, 7, 8 in an arrangement for carrying out a method for producing honed segment bores 5 to 8 in the work pieces 1 to 4. The work pieces 1 to 4 can thereby in each case be rigidly mounted. The work pieces 1 to 4 are arranged relative to each other such that the individual segment bores 5 to 8 of the work pieces 1 to 4 are aligned to a common longitudinal axis 9. Each of the individual bore axes of the segment bores 5 to 8 is therefore identical to the longitudinal axis 9, or rather said individual bore axes lie at least approximately on the longitudinal axis 9. In this exemplary embodiment, the work pieces 1 to 4 are arranged distributed along the longitudinal axis 9. This arrangement is required in this exemplary embodiment because the individual segment bores 5 to 8 are designed in each case having segments of 180° or more, in this case of more than 180°.

In addition, the work pieces 1 to 4 are arranged around the longitudinal axis 9 such that a projection along the common longitudinal axis 9 forms a closed circle. The direction of the projection is denoted in FIG. 1 with the symbol II. For this purpose, the work pieces 1 to 4 are arranged in a suitable manner with respect to the longitudinal axis 9 or skewed with respect to said longitudinal axis 6. By layering and skewing the work pieces 1 to 4 with respect to each other, a closed circle consequently results in the projection, as it can be seen in FIG. 2. A multiple superposition is preferably formed thereby, which can be twofold or also more than twofold. In so doing, a reliable guidance for a honing tool 10 results, said honing tool comprising a honing mandrel.

The honing tool 10 is guided along the longitudinal axis 9 through the segment bores 5 to 8 of the workpieces 1 to 4. A feed direction, corresponding to the viewing direction denoted with the reference symbol II, is thereby aligned to the common longitudinal axis 9. The honing tool 10 is therefore moved along said longitudinal axis 9 in order to hone the segment bores 5 to 8. Said honing tool 10 can in this case be gimbal-mounted.

It is also an option for the honing tool 10 to be rigidly mounted while the work pieces 1 to 4 are gimbal-mounted. Other combinations of tool and work piece mounting are also possible.

An advantageous clamping of the work pieces 1 to 4 relative to each other is therefore specified, which facilitates a reliable guiding of the honing tool 10. In so doing, honed segment bores 5 to Scan be designed in the work pieces 1 to 4.

FIG. 2 shows the arrangement of the work pieces 1 to 4 from the viewing direction denoted in FIG. 1 with the reference symbol II. The two segment bores 5, 6 of the work pieces 1 to 2 are put together such that said bores have the common longitudinal axis 9. Because the two segment bores 5 to 6 extend respectively in this exemplary embodiment over segments of more than 180°, in particular the segment bore 5 of the work piece 1 extends over a segment 11 of, for example, 210°, a closed circle 12 can be formed by the segment bores 5, 6 by means of the opposing arrangement of the work pieces 1 to 4. As a result, the two work pieces 1, 2, which are arranged adjacent to each other on the longitudinal axis 9, have a minimal overlap. The work pieces 3 to 4 are also correspondingly arranged. When honing the segment bores 5 to 8 of the work pieces 1 to 4, an advantageous guidance of a honing mandrel thereby results.

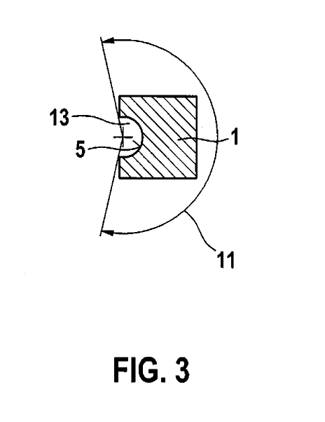

FIG. 3 shows the work piece 1 in a schematic cross-sectional depiction. Said work piece 1 can especially be designed as a bearing element 1. Said work piece 1 comprises the honed segment bore 5, which can serve as a bearing surface 5. The bearing surface 5 can, for example, serve to mount a roller. The segment bore 5 is thereby formed by a partially cylindrical recess 13 so that the bearing surface 5 lies on a cylinder jacket.

When honing the segment bore 5 of the work piece 1 together with the segment bores 6, 7, 8 of the work pieces 2, 3, 4, typical machining marks arise on the segment bore 5 and also on the other segment bores 6 to 8. Said machining marks which are typical of the method and which occur on the honed segment bore 5 have a positive effect on the sliding and lubrication properties.

In this exemplary embodiment, The work piece 1 comprises a honed segment bore 5, which extends over a segment 11 of more than 180°. The work piece 1 can also comprise a segment bore 5 in the form of a half-shell bore, wherein the segment 11 then extends at least approximately around 180°. Other embodiments are also possible. The segment 11 of the segment bore 5 can, for example, also be less than 180°. Depending on the size of the segment 11 of the individual work pieces 1 to 4, a certain minimum number of work pieces which are required to form a closed circle 12 results. It is however preferable for a greater number of work pieces to be arranged in order to achieve a multiple superposition in the configuration the closed circle 12. On the one hand, an advantageous guidance of the honing tool 10 is thereby achieved; and on the other hand, a greater number of work pieces can be processed simultaneously, thus reducing the cycle time.

The invention is not limited to the exemplary embodiments which have been described.

1. (canceled)

2. The method according to claim 9, characterized in that the work pieces (1-4) are arranged relative to each other such that in the projection along the common longitudinal axis (9), the segment bores (5-8) of said work pieces (1-4) form the closed circle (12) in a multiple superposition.

3. The method according to claim 9, characterized in that the work pieces (1-4) are rigidly arranged and in that a honing mandrel (10), which in order to hone the segment bores (5-8) of the work pieces (1-4) arranged relative to each other is guided with a feed along the common longitudinal axis (9) through said segment bores (5-8), is gimbal-mounted.

4. The method according to claim 29, characterized in that the work pieces (1-4) are in each case gimbal-mounted and in that a honing mandrel (10), which in order to hone the segment bores (5-8) of the work pieces (1-4) arranged relative to each other is guided relative to said work pieces (1-4) along the common longitudinal axis (9) through the segment bores (5-8), is rigidly mounted.

5. A work piece (1) comprising a segment bore (5), wherein the segment bore (5) is designed as a honed segment bore (5), characterized in that said segment bore extends over a segment of more or less than 180°.

6. The work piece according to claim 5, characterized in that the work piece (1) is a bearing element (1) and in that the honed segment bore (5) serves as a bearing surface (5).

7. The work piece according to claim 5, characterized in that the honed segment bore (5) is designed as a partially cylindrical, honed segment bore (5).

8. The work piece according to claim 5, characterized in that the honed segment bore (5) serves to receive a roller.

9. A method for producing honed segment bores (5-8) in work pieces (1-4), which each have a segment bore (5-8), the method comprising:
arranging the work pieces (1-4) relative to each other such that the segment bores (5-8) of the work pieces (1-4) are aligned to a common longitudinal axis (9) and a closed circle (12) is formed in a projection along the common longitudinal axis (9);
arranging the work pieces (1-4) at least partially distributed along the longitudinal axis (9);
arranging at least two adjacent work pieces (1, 2) of said work pieces (1-4) distributed along said longitudinal axis (9) around said common longitudinal axis (9) such that the segment bores (5, 6) of the adjacent work pieces (1,2) have a slight overlap in the projection along said common longitudinal axis (9); and
thereafter honing together the segment bores (5-8) of the work pieces (1-4).

10. The method according to claim 2, characterized in that the work pieces (1-4) are rigidly arranged and in that a honing mandrel (10), which in order to hone the segment bores (5-8) of the work pieces (1-4) arranged relative to each other is guided with a feed along the common longitudinal axis (9) through said segment bores (5-8), is gimbal-mounted.

11. The method according to claim 2, characterized in that the work pieces (1-4) are in each case gimbal-mounted and in that a honing mandrel (10), which in order to hone the segment bores (5-8) of the work pieces (1-4) arranged relative to each other is guided relative to said work pieces (1-4) along the common longitudinal axis (9) through the segment bores (5-8), is rigidly mounted.

12. The work piece according to claim 6, characterized in that the honed segment bore (5) is designed as a partially cylindrical, honed segment bore (5).

13. The work piece according to claim 12, characterized in that the honed segment bore (5) serves to receive a roller.
